(19) United States
(12) Patent Application Publication
(10) Pub. No.: US 2010/0105346 A1
(43) Pub. Date: Apr. 29, 2010

(54) METHOD TO DETECT INTERFERENCE IN WIRELESS SIGNALS

(75) Inventors: Kee-dyi Huang, Cupertino, CA (US); Bhaskar Thiagarajan, Campbell, CA (US); Randy L. Lundquist, Shelley, ID (US); Vaidyanathan Venugopal, Santa Clara, CA (US)

Correspondence Address: FLIESLER MEYER LLP, 650 CALIFORNIA STREET, 14TH FLOOR, SAN FRANCISCO, CA, 94108, US

(73) Assignee: Anritsu Company, Morgan Hill, CA (US)

(21) Appl. No.: 12/258,108

(22) Filed: Oct. 24, 2008

(51) Int. Cl. H04B 1/10; H04B 15/00

(52) U.S. Cl. 455/226.4; 455/296

(57) ABSTRACT

A method to detect interference in wireless signals, comprising sampling a received signal; identifying a dominant waveform in the received signal; subtracting the dominant waveform from the received signal to create a modified received signal; and repeating the above steps, recursively substituting the modified received signal for the received signal, until all adjusted reference waveforms have been subtracted.

### CROSS-REFERENCE TO RELATED APPLICATIONS

This application is related to the following co-pending application:

U.S. patent application Ser. No. 12/______, entitled APPARATUS TO DETECT INTERFERENCE IN WIRELESS SIGNALS, by Kee-dyi Huang, Bhaskar Thiagarajan, Randy L Lundquist, and Vaidyanathan Venugopal, filed Oct. 24, 2008 (Attorney Docket No. ANRI-08097US0);

### BACKGROUND

1. Technical Field

The present invention relates to methods for detecting interference in wireless signals

2. Related Art

Signal interference is the inevitable result of the proliferation of wireless systems. Home networking, Bluetooth enabled devices, broadcast digital television, or even a microwave oven, can all contribute potential interference. Regulatory and environmental restrictions further compound these problems by limiting the distribution of new transmitter sites, forcing base station transceivers to share towers.

There are several methods on the market today designed to detect interference which may affect the quality of wireless signals. These methods may be implemented in, for example, the Anritsu MT8222A Base Station Analyzer and the MS272xB line of Spectrum Analyzers, all available from Anritsu Company, Morgan Hill, Calif. Several methods of measuring and analyzing interference including measuring signal strength, received signal strength indication (RSSI), spectrograms, real-time scanning, and Error Vector Spectrum (EVS) may be included in these and other devices. However, when interference is weak enough to be buried under the spectrum of the desired signal and when the desired signal is present during the entire period of time that the interference is present, current methods' ability to detect interference is weakened.

Thus, it is desirable to provide a method for detecting interference in wireless signals.

### SUMMARY

According to embodiments of the present invention, a method is provided to detect interference in a received signal by modifying the received signal to remove sequentially deterministic components.

In one embodiment of the present invention, any wireless communication signal that includes sequentially deterministic components can be modified to detect interference. The sequentially deterministic components include portions of the signal that are made of predefined sequences. Examples of sequentially deterministic components include Pilot sequences in Code Division Multiple Access-based (CDMA-based) wireless technologies and Preambles in Worldwide Interoperability for Microwave Access (WiMAX). Because these components are predefined, they can be removed using ideal reference waveforms. The ideal reference waveforms are the ideal versions of the sequentially deterministic components for a given signal type of interest.

The received signal can be cross-correlated with the ideal reference waveforms to identify a dominant waveform and its characteristics in the received signal. The characteristics may include frequency, phase, and time offset and power. Using this information, the ideal reference waveform corresponding to the dominant waveform can be adjusted and subtracted from the received signal. This process can be repeated until no more dominant waveforms can be identified or until all reference waveforms have been subtracted. The resulting signal will be left with the interference that was previously undetectable. This can be analyzed using a spectrum analysis procedure to view the residual spectrum and identify possible sources of interference.

### BRIEF DESCRIPTION OF THE DRAWINGS

Further details of the present invention are explained with the help of the attached drawings in which:

FIG. 1 shows a signal environment.

FIG. 2 shows a diagram of a wireless signal received by a user-device in accordance with an embodiment.

FIG. 3 shows a diagram of several wireless signal standards.

FIG. 4 shows a method for constructing ideal reference waveforms in accordance with an embodiment.

FIG. 5 shows an illustration of construction of ideal reference waveforms in accordance with an embodiment.

FIG. 6 shows a method for detecting interference in wireless signals in accordance with an embodiment.

FIG. 7 shows an example of a cross-correlation of a sampled signal and a set of Pilot sequences.

FIG. 8 shows a device in accordance with an embodiment.

### DETAILED DESCRIPTION

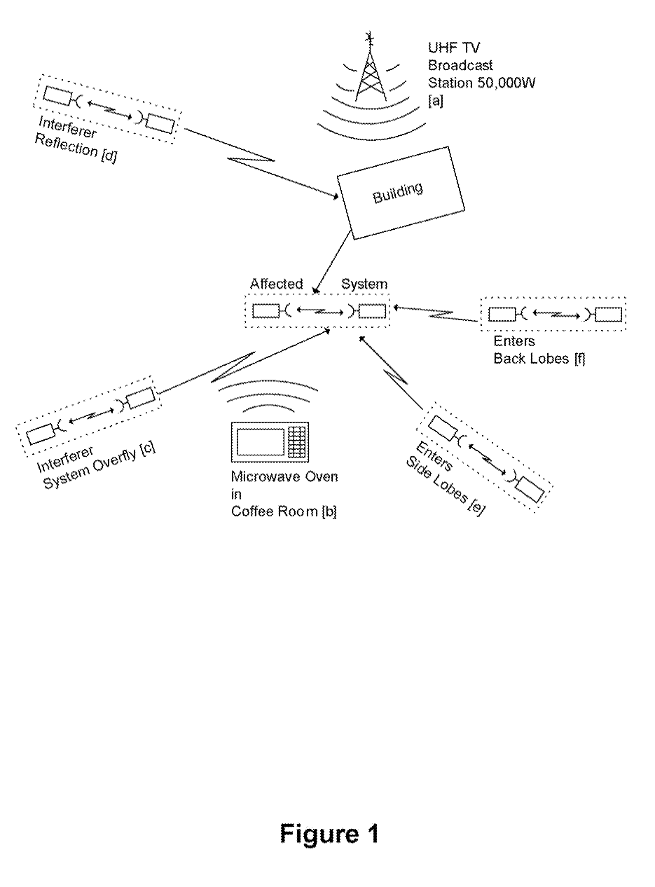

FIG. 1 shows a signal environment. As shown in FIG. 1, a system may receive many signals in addition to the desired signal. These additional signals, or sources of interference, can negatively affect the quality of the desired signal. For example, a microwave oven, 1b, may cause in-band interference if it is not shielded properly. Other sources, such as 1c, may overfly their intended receivers causing interference in the affected system. Other signals, such as 1e and 1f may be received through side or back lobes of the affected system's receiver. Additionally, nearby buildings can cause signals to be reflected to the affected system's receiver. These obstructions can also cause interference due to the intended signal being received from multiple paths causing signal degradation. Out-of-band signals can also cause interference. At 1a is a high-powered transmitter broadcasting ultra high frequency (UHF) television signals. While this signal may be out of band for the affected system, the signal may still leak through the system's filters causing distortion.

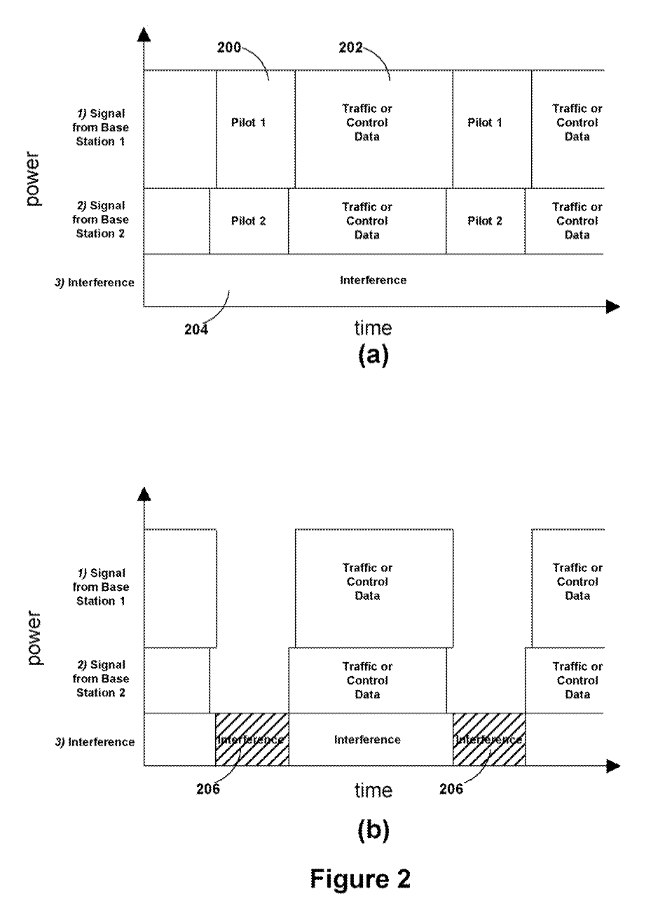

FIG. 2 shows a diagram of a wireless signal received by a user-device in accordance with an embodiment. A signal received by a user device may be made up of signals from one or more base stations operating in the same frequency channel. As shown in FIG. 2a, a user device is receiving signals from base station 1 and base station 2, in addition to unknown interference sources. Each signal includes a pilot component 200 and a data component 202. The pilot component is a time period where the signal includes sequentially deterministic components, in other words the signal for that time period is made up from a pool of pre-defined sequences. For Code Division Multiple Access-based (CDMA-based) technologies this is called the Pilot component. Other technologies may also include a sequentially deterministic component, for example in Worldwide Interoperability for Microwave Access (WiMAX) it is called the Preamble, and in Global System for Mobile Communications (GSM)/Enhanced Data Rates for Global Evolution (EDGE) it can be the Frequency Correction Burst (FCCH) in Broadcast Control Channel (BCCH) or Training Sequence Code in a traffic channel. While specific examples are noted above, this list is not exhaustive, and the method of the present invention is equally applicable to any signal that includes a sequentially deterministic component for a given time period. As further shown in FIG. 2b, if these sequentially deterministic components are removed from the signal received by the user device, then all that is left are the interfering signals 206.

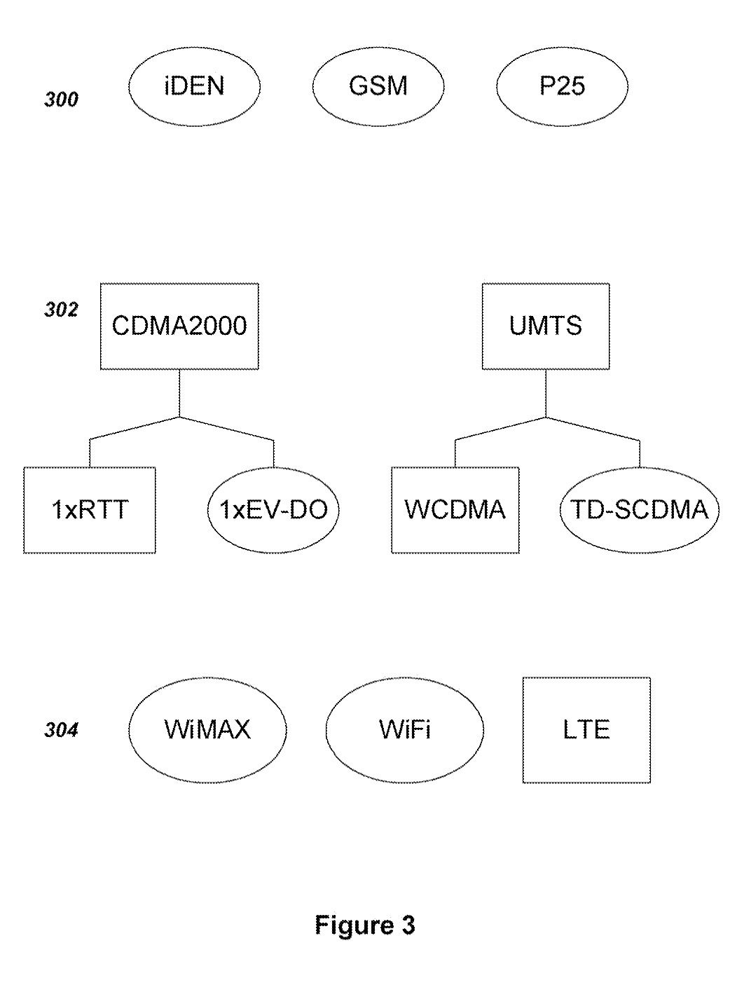

FIG. 3 shows a diagram of several wireless signal standards. As described above, any signal that includes a sequentially deterministic component for a given time period can be used with the present invention. While not exhaustive, FIG. 3 illustrates several signal standards, and differentiates between those which include this time domain multiplex characteristic and those which do not. At 300, Project 25 (P25), Integrated Digital Enhanced Network (iDEN), and GSM are listed. All of these standards are circled, indicating that they include the desired characteristic. At 302 are CDMA-based wireless technologies. These include Universal Mobile Telecommunications System (UMTS) and cdma2000. UMTS is a part of the International Telecommunications Union's vision of a global family of third generation (3G) mobile communications systems. Similarly, cdma2000 represents a family of technologies being implemented in North America and Asia, but not in Europe. Thus, as shown in FIG. 3, multiple signal standards are members of the UMTS and cdma2000 families. Both UMTS and cdma2000 families are referred to herein as CDMA-based technologies. Of the CDMA-based technologies listed, 1× Evolution Data Only (1×EV-DO) and Time Division Synchronous Code Division Multiple Access (TD-SCDMA) include sequentially deterministic components in time domain and are circled. Finally, at 304, WiMAX, Wireless Fidelity (WiFi), and Long Term Evolution of Universal Terrestrial Radio Access Network (LTE) are shown. Of these, WiMAX and WiFi include this time domain multiplex characteristic. The method of the present invention may be used with, among other signal standards, any of the above identified signal standards that include time domain sequentially deterministic components.

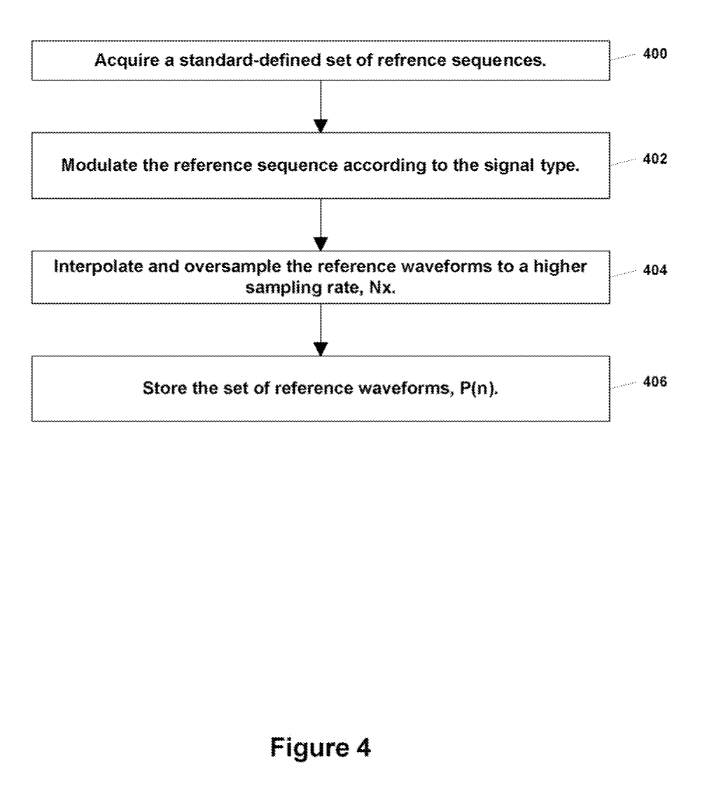

FIG. 4 shows a method for constructing ideal reference waveforms in accordance with an embodiment. In one embodiment, a set of ideal reference waveforms are used to remove the sequentially deterministic components from the received signal. The ideal reference waveforms are the ideal sequentially deterministic components for a particular signal type of interest. For example, if the invention is applied to a CDMA-based signal with time domain multiplex characteristics, the set of ideal reference waveforms will include the ideal Pilot codes. At block 400, a set of standard-defined reference sequences are acquired. This set may be provided in the form of sequences of bits, or by a sequence generating formula, described in the signal standard's specification documents. At block 402, the reference sequences are modulated according to the signal type. A modulated waveform can be represented as two components, an in-phase (I) component, and a quadrature phase (Q) component that is 90 degrees out of phase from the in-phase component. The I and Q components are related such that the waveform at any given time is equal to I+Qj. The magnitude of the signal is given by |I+QJ| and its phase is given by ∠(I+Qj). This step may further include pulse-shaping, equalization, or conversion from the frequency domain to the time domain, depending on the signal type. At block 404, the waveforms are interpolated and oversampled to an Nx sampling rate. Oversampling is relative to the rate that is native to the standard-defined sequence, therefore 1× sampling rate is equivalent to the rate of the standard-defined sequence and Nx is the oversampled rate where N is greater than one. Interpolation and over-sampling are optional. By interpolating and oversampling the ideal waveform, a waveform is created that more closely resembles the waveform one may receive in practice. At block 406, the set of ideal reference waveforms, P(n), are stored, n being the index of each reference waveform. The method shown in FIG. 4 can be completed and the results stored for future use, as further described below.

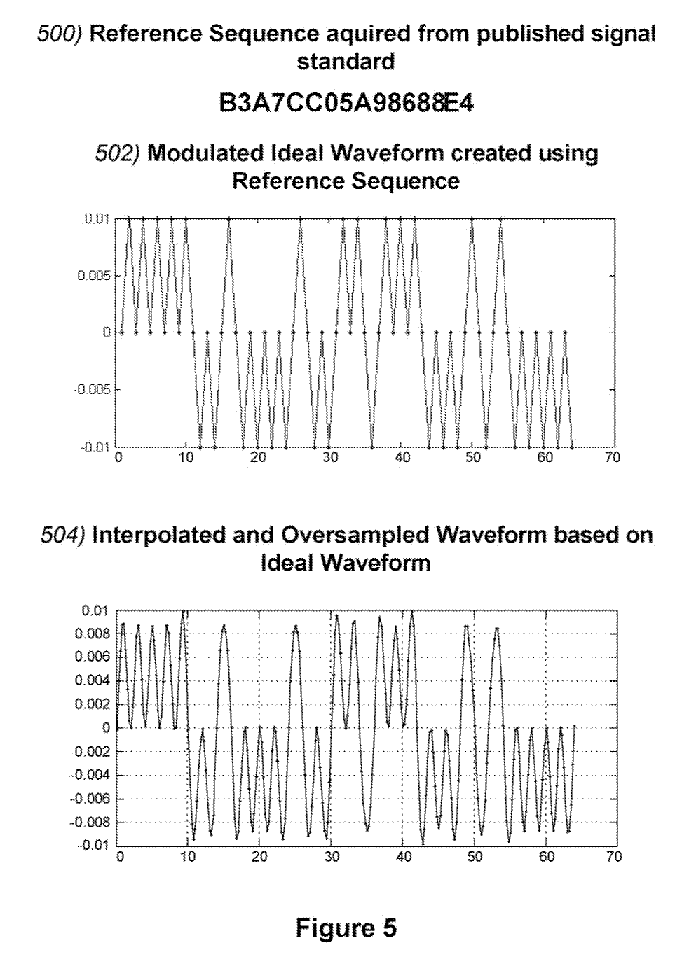

FIG. 5 shows an illustration of construction of ideal reference waveforms in accordance with an embodiment. At 500, a reference sequence is acquired. As shown at 500, this may be a hexadecimal sequence, however, other digital formats, such as binary sequences, may be used. Additionally, the sequence shown at 500 is just one sequence of thirty-two from the TD-SCDMA standard. As described above with respect to block 402, modulation of each reference sequence transforms the sequence of real numbers (as shown at 500) into a sequence of complex numbers representing the in-phase (I) and out-of-phase (Q) components of the reference waveform. At 502, the in-phase (I) component of the ideal waveform constructed from the reference sequence is shown. At 504, the I component of the ideal waveform is shown after being pulse-shaped and interpolated. The pulse-shaped and interpolated waveform more closely resembles a waveform that may actually be received in practice. As can be seen at 504, the pulse-shaped and interpolated waveform has been oversampled at a rate of 4× (i.e., in the nomenclature of FIG. 4, N=4). When compared with the waveform at 502, it is clearly seen that there are now four points in 504 for every point in 502. By using the interpolated and modulated waveform, the present invention is much more sensitive than methods of the prior art.

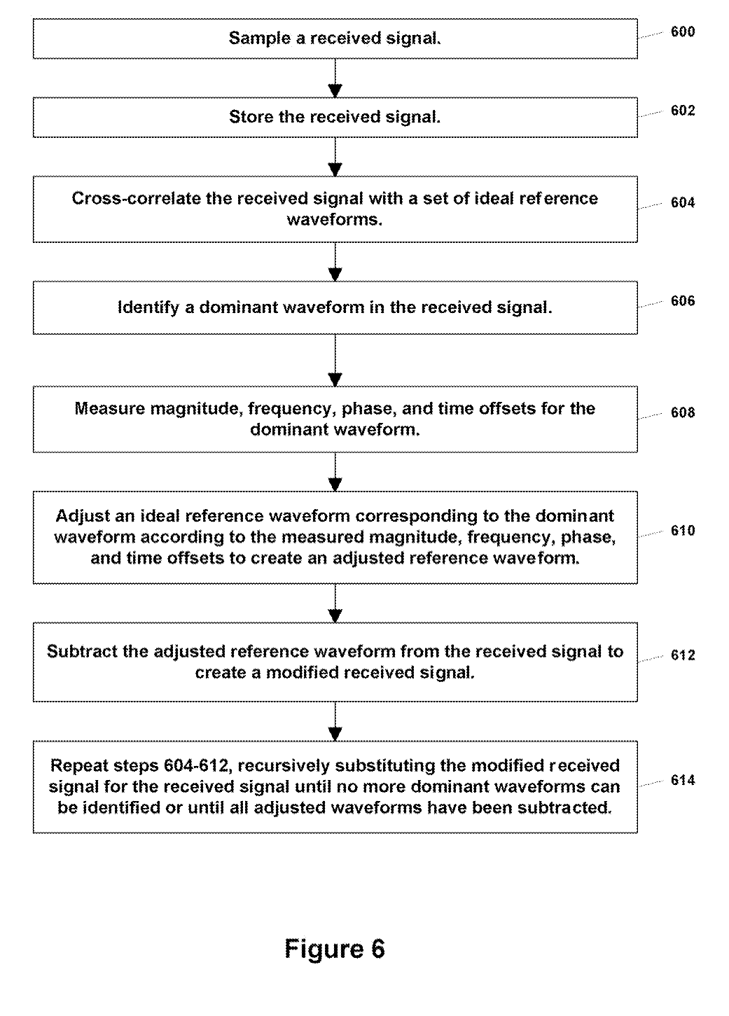

FIG. 6 shows a method for detecting interference in wireless signals in accordance with an embodiment. At block 600, a signal of interest is received and sampled. As noted above, embodiments of the present invention can be used with many signal types including CDMA-based signals such as TD-SCDMA and 1×EV-DO, WiMax signals, iDEN signals, GSM/EDGE signals, and any signal that for a period of time comprises sequentially deterministic components. The received signal is sampled at the same sampling rate (Nx) as described in FIG. 4. At block 602, the sampled signal, Rx(t), is stored. The sampled signal is stored as a complex sequence in the I and Q domain. In one embodiment, the method of the present invention may be implemented in a device that includes a computer readable storage medium. In such an embodiment, the sampled signal may be stored in the computer readable storage medium. At block 604, the received signal is cross-correlated with a set of ideal reference waveforms, P(n). The set of ideal reference waveforms is constructed according to the method described in FIG. 4. The result of the cross-correlation is a two dimensional array of complex numbers, C(t,n), which is a collection of the cross-correlation of each ideal reference waveform and the received signal.

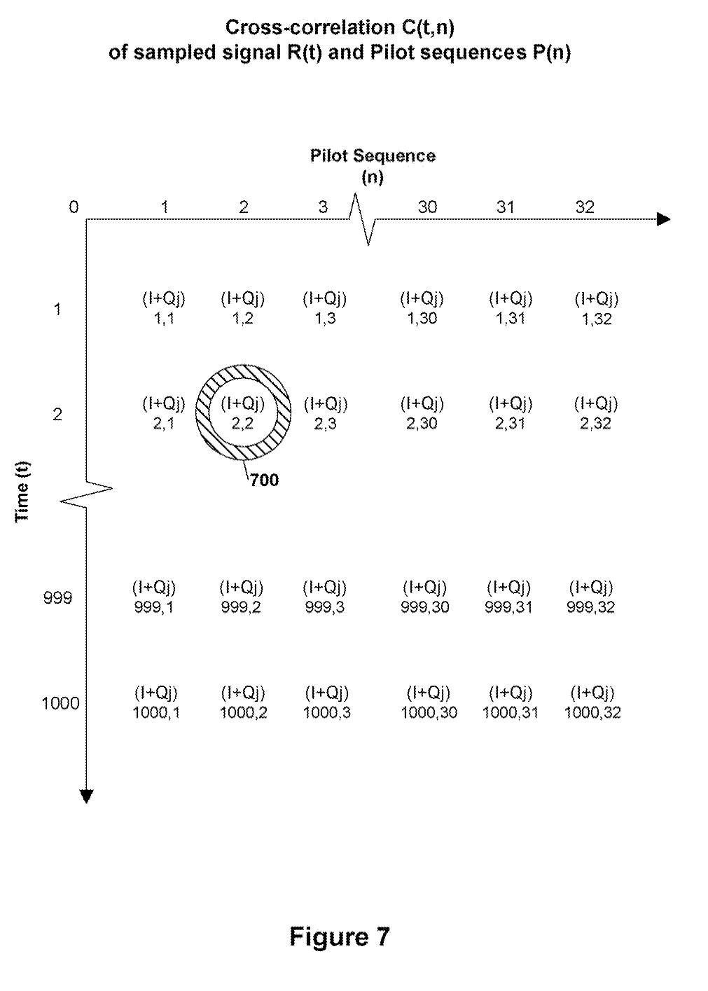

FIG. 7 shows an example of a cross-correlation of a sampled signal and a set of ideal reference waveforms. In the example of FIG. 7, 32 ideal reference waveforms, P(n), have been cross-correlated with the sampled signal Rx(t). As described above, both the ideal reference waveforms and the sampled signal are stored as complex sequences in the I and Q domain. Accordingly, the resulting cross-correlation is a two dimensional array of complex values in the I and Q domain. Each column corresponds to a different ideal reference waveform, shown as 1 through 32. Each row corresponds to a different discrete time period, shown as 1 through 1000. Some values for C(t,n) will have a much higher magnitude than others. For example, in FIG. 7, at 700, C(2,2) has been identified as having the greatest magnitude, |C(2,2)|. Accordingly, P(2) identifies the dominant waveform and time 2 identifies the time period at which the dominant waveform starts. The phase offset can be measured by calculating the phase of C(2,2). The exact time offset can be obtained by fine time-shifting P(2) and correlating it with Rx(t) to find the maximum correlation value. Additionally, the frequency offset can be measured using conventional methods such as measuring the phase-time relationship of P(2) and Rx(t).

Returning to FIG. 6, at block 606, the dominant waveform is identified. The magnitude of C(t,n) is used to identify the dominant waveform. The magnitude associated with a time period, tₖ, and a waveform, k, will be greater than other times and waveforms. Thus, Rx(tₖ) identifies the portion of the received signal that includes the sequentially deterministic components and P(k) identifies the ideal reference waveform corresponding to the dominant waveform. At block 608, the frequency, phase, time offset, and power of the dominant waveform are measured. These characteristics can be measured as described above with respect to FIG. 7. At block 610, the ideal reference waveform corresponding to the dominant waveform, P(k), is adjusted according to the measured frequency, phase, time offset, and power to create an adjusted reference waveform. Thus, if C(t₁,1) has the greatest magnitude of C(t,n) and is identified in block 606 as the dominant waveform, then P(1), the corresponding ideal reference waveform, is adjusted according to the measured characteristics of the dominant waveform creating P_{adj}(1), an adjusted reference waveform.

At block 612, the adjusted reference waveform, P_{adj}(k), is subtracted from the received signal, Rx(t), to create a modified received signal, Rx′(t). At block 614, steps 604-612 are repeated, recursively substituting the modified received signal, Rx′(t), for the received signal, Rx(t), until no more dominant waveforms can be identified or until all available reference waveforms have been subtracted. The resulting Rx′(t) is as shown at 206 in FIG. 2b, the reference waveforms have been removed leaving the interfering signal(s).

In one embodiment, a noise floor is estimated based on the cross-correlation of the sampled signal and the ideal reference waveforms. Some signal standards limit the total pool of waveforms that can be present in a signal at any time, therefore the noise floor can be estimated from the power of any waveforms detected in addition to the standard-set limit. Additionally, under signal standards where there is no set limit, physical limitations (such as geography) make the presence of a large number of waveforms unlikely. Therefore, the noise floor can be estimated based on the power of the weakest waveforms detected. Thus, if no waveform is detected with a peak-magnitude above the estimated noise floor, then no dominant waveform remain in the sampled signal.

In one embodiment, each dominant waveform identified in block 606, along with its characteristics measured in block 608, can be shown on a display, providing a very sensitive reading of the waveforms present in the received signal. Thus, secondary signals, those waveforms identified as dominant after the first dominant waveform has been removed, may be detected with greater sensitivity than in conventional methods used in Base Station scanning.

In another embodiment, the results of the method can be used for spectrum analysis. As each dominant waveform is removed from the received signal, the spectrum analyzer can perform a Fourier transform on each resulting Rx′(t). Each spectrum, including the Residual Spectrum (i.e., the spectrum of the remaining signal after all dominant waveforms have been removed) can be displayed on the spectrum analyzer. Analysis can then be performed on the spectra to identify the source of the interference.

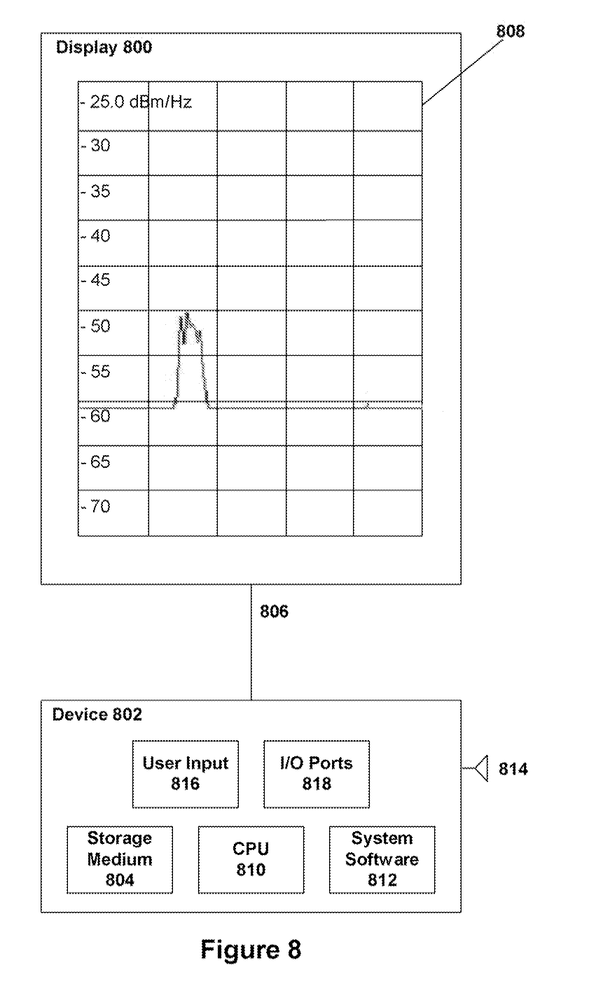

For example, as shown in FIG. 8, the method of the present invention may be implemented in a device 802 that includes a computer readable storage medium 804 and antenna 814 for receiving wireless signals, including cellular and wireless area network signals as described above. In one embodiment, the device is coupled 806 to a display 800. The computer readable storage medium 804 may include Flash memory. The device may also include a CPU 810 and stored system software 812. Additionally, the device may include a user input mechanism 816 including, but not limited to, soft keys and hard keys, touch screen, etc. The device may further include a variety of input/output (I/O) ports 818. These ports may include, for example, universal serial bus (USB) and Ethernet ports. In one embodiment, the device may be configured to display the spectrum 808 of the signal that remains after the dominant waveforms have been removed. Additionally, a conventional spectrum analysis result (the original spectrum before any signal component is removed) may be superimposed in a different color on top of this Residual Spectrum trace for comparison purposes.

Although the present invention has been described above with particularity, this was merely to teach one of ordinary skill in the art how to make and use the invention. Many modifications will fall within the scope of the invention, as that scope is defined by the following claims.

What is claimed:

1. A method to detect secondary signals in wireless signals, the method comprising:
receiving a signal including a first component and a second component wherein each component is from a different signal source;
identifying the first component of the signal; and
removing the first component of the signal and leaving the second component of the signal.

2. The method of claim 1 wherein the first component of the signal includes at least one predefined component in accordance with a signal type of interest and wherein the second component of the signal includes a portion of the signal not included in the first component.

3. The method of claim 1 further comprising:
analyzing the spectrum of the second component of the signal; and
displaying a spectrum of the second component of the signal on a display.

4. The method of claim 1 further comprising:
analyzing the first component of the signal;
measuring characteristics of the first component of the signal; and
displaying the first component of the signal along with its characteristics on a display.

5. A method to detect interference in wireless signals, the method comprising:
(a) receiving a signal;
(b) identifying a dominant waveform in the received signal;
(c) removing the dominant waveform from the received signal to create a modified received signal; and
(d) repeating steps b-c, recursively substituting the modified received signal from step c for the received signal, until all dominant waveforms have been removed.

6. The method of claim 5 wherein identifying a dominant waveform comprises:
cross-correlating the received signal with a set of ideal reference waveforms; and
identifying a waveform with a highest correlation value as the dominant waveform.

7. The method of claim 5 wherein removing the dominant waveform comprises:
measuring frequency, phase, and time offset and power for the dominant waveform;
adjusting an ideal reference waveform corresponding to the dominant waveform according to the measured frequency, phase, and time offset and power to create an adjusted waveform; and
subtracting the adjusted waveform from the received signal.

8. The method of claim 6 wherein the set of ideal reference waveforms is constructed according to the steps of:
acquiring a standard-defined set of reference sequences;
modulating the reference sequences according to a signal type associated with the reference sequences;
storing the reference waveforms as a set of ideal reference waveforms.

9. The method of claim 8 wherein the modulated reference waveforms are interpolated and over-sampled before being stored.

10. A method to detect interference in wireless signals, the method comprising:
(a) sampling a received signal;
(b) storing the received signal;
(c) cross-correlating the received signal with a set of ideal reference waveforms;
(d) identifying a dominant waveform in the received signal;
(e) measuring frequency, phase, and time offset and power for the dominant waveform;
(f) adjusting an ideal reference waveform corresponding to the dominant waveform according to the measured frequency, phase, and time offset and power to create an adjusted reference waveform;
(g) subtracting the adjusted reference waveform from the received signal to create a modified received signal; and
(h) repeating steps c-g, recursively substituting the modified received signal from step g for the received signal, until all dominant waveforms have been subtracted.

11. The method of claim 10 wherein the received signal is received through an antenna.

12. The method of claim 10 wherein the set of ideal reference waveforms is created by the steps of:
acquiring a standard-defined set of reference sequences in discrete time format;
modulating the reference sequences according to a signal type to which the reference waveforms correspond;
storing the reference waveforms.

13. The method of claim 12 wherein the reference sequences are interpolated and oversampled to an Nx sampling rate, wherein the Nx sampling rate is greater than a rate associated with the standard-defined set of reference sequences.

14. The method of claim 13 wherein the cross-correlation is performed at the Nx sampling rate.

15. The method of claim 14 wherein modulating includes pulse shaping or equalization for reference waveforms as specified in the respective signal standards, e.g. 1×EV-DO, TD-SCDMA or EDGE/GSM.

16. The method of claim 14 wherein modulating includes performing a discrete inverse Fourier transform for reference waveforms corresponding to OFDM signals.

17. The method of claim 10 further comprising:
performing a Fourier transform on the modified received signal; and
displaying the transformed modified received signal on a spectrum analyzer.

18. The method of claim 10 further comprising:
displaying each dominant waveform along with its measured power and time offset.

19. The method of claim 10 wherein identifying a dominant waveform includes determining which reference waveform generates a highest correlation value in the cross-correlation.

20. The method of claim 10 wherein the received signal is filtered and pulse-shaped.

21. The method of claim 10 wherein the received signal is a cellular or wireless area network signal.
